(19) United States
(12) Patent Application Publication
(10) Pub. No.: US 2011/0228337 A1
(43) Pub. Date: Sep. 22, 2011

(54) DELIVERY TRANSFER SYSTEM AND DELIVERY ORDER FORM PRINTING PROGRAM

(75) Inventors: Yuji Shikano, Tokyo (JP); Rie Shikano, Tokyo (JP)

(73) Assignee: DIGITAL CONCEPT, INC., Tokyo (JP)

(21) Appl. No.: 13/131,747

(22) PCT Filed: Nov. 13, 2009
(86) PCT No.: PCT/JP2009/006077

§ 371 Date: May 27, 2011

(30) Foreign Application Priority Data
Nov. 30, 2008 (JP) 2008-305794
May 1, 2009 (JP) 2009-111917

(51) Int. Cl. G06F 3/12

(52) U.S. Cl. 358/1.15

(57) ABSTRACT

This invention provides a delivery transfer system capable of transferring to the delivery company a parcel to be delivered to a delivery location specified by a client, and returning to the client compensation for inclusion of specific information on a delivery order form. The system comprises registration means wherein client information from a client is registered, receiving means that receives client information that identifies the client and delivery destination information of a parcel, advertisement selection means that selects specific information based on the delivery destination information, and reply sending means that sends to the client a reply with a parcel identification code, which is issued from a delivery management system, affixed to the parcel, and then registered in the delivery management system to identify the parcel, along with the selected specific information, and enables print out of the delivery destination information, the parcel identification code, and the specific information as the delivery order form.

### TECHNICAL FIELD

The present invention relates to a delivery transfer system provided separately from a delivery management system of a delivery company, that is capable of transferring to the delivery company a parcel to be delivered to a delivery location specified by a client, and returning to the client compensation for inclusion of specific information on a delivery order form, and a delivery order form printing program used therein.

### BACKGROUND ART

There are delivery companies that deliver parcels to delivery locations specified by clients. Among such delivery companies, large-scale delivery companies that deliver a great number of parcels nationwide on a daily basis utilize transportation means (scheduled flights) for periodically moving the parcels between several distribution centers. As these delivery companies relay the parcels between the distribution centers, they deliver the parcels to the delivery locations specified by the clients. For example, a parcel brought to a contracted service office, etc., of the delivery company is temporarily carried to a predetermined distribution center that has jurisdiction over that area. Then, as the parcel is relayed between distribution centers by the above-described transportation means (scheduled flights), the parcel is carried to the distribution center that has jurisdiction over the delivery location specified by the client, and finally delivered to the delivery location by a driver. Such complex parcel delivery is centrally managed by a delivery management system (server) unique to that delivery company.

Specifically, for example, the names, zip codes, addresses, and telephone numbers of the client (sender) and destination, the parcel contents, and the like are written down by the client on a delivery order form provided with an approximate 12-digit code comprising numbers, letters, symbols, or a combination thereof, and the delivery order form is affixed to the parcel. The parcel having the attached delivery order form is carried to the contracted service office of the delivery company. The contracted service office calculates the delivery fee from the address and zip code of the destination stated on the delivery order form as well as from the parcel size and the like, and receives payment. On the other hand, regardless of the delivery destination, since such a parcel is temporarily carried to a predetermined distribution center having jurisdiction over that area, there is no need to sort the parcel in accordance with the delivery destination, etc., at the contracted service office, so no particular action needs to be performed on the distribution management system.

At the first distribution center, the code on the parcel's delivery order form is registered in the delivery management system. Thereafter, this code is used as a parcel identification code to track the parcel using the delivery management system. At this first distribution center, the final distribution center that has jurisdiction over the delivery destination is visually found from the address of the delivery destination on the delivery order form or from the zip code or telephone number on the delivery order form using search means, then the transportation means (scheduled flight) is determined, and the parcel is sorted accordingly. At each distribution center through which the parcel passes, the parcel identification code on the delivery order form is sent to the delivery management system when the parcel is relayed. When the parcel identification code on the delivery order form is sent from the final distribution center to the delivery management system and the driver subsequently delivers the parcel to the destination, the driver sends the parcel identification code of the delivery order form and a delivery completion notification to the delivery management system using a handheld device or the like. In this manner, the delivery management system makes it possible to identify from the parcel identification code the distribution center, etc., at which the parcel is currently located, and enables the sender and the recipient at the destination to check such information using an Internet service or the like.

Now, many new businesses that utilize the above-described delivery order form have been proposed. For example, since a delivery order form attached to a parcel is viewed by at least two persons, the client and the recipient, the form can be utilized as a highly effective advertising medium compared to DM (direct mail) or the like that is viewed by the recipient only.

For example, in PTL 1 and PTL 2 are proposed delivery order forms provided with such an advertising function. Specifically, a predetermined advertisement is printed in advance on such a delivery order form and the delivery order form is directly distributed by hand or by post to a client from a delivery company contracted to deliver parcels. The client then writes predetermined order form information such as described above on the delivery order form, affixes the form to the parcel, and requests the delivery company to deliver the parcel.

Furthermore, in PTL 3 is disclosed a system that connects a client and a delivery management system of a delivery company via the Internet and, once the required information is sent to the delivery management system, sends a reply to the client with the order form information, enabling the client to print out the delivery order form at his/her home, etc. In such a system, the prior art also states, “unique print data” of an advertisement, etc., are extracted from a database and printed on the delivery order form along with the order form information.

### CITATION LIST

### Patent Literature

PTL 1: JP 3098933 Y

PTL 2: JP 2006-62295 A

PTL 3: JP 2004-269264 A

### SUMMARY OF INVENTION

### Technical Problem

A delivery order form provided with an advertising function is naturally viewed by at least two persons, the client and the recipient, to verify the entered information related to delivery on the delivery order form. If this advertisement reflects the client or the recipient, that is, for example, if the advertisement reflects the location information or interest information of the recipient, the order form becomes a more effective advertising medium, making it possible to set a high advertisement fee and return that fee as compensation for the advertisement to the client, and reduce the delivery cost.

Here, according to the delivery order forms disclosed in PTL 1 and PTL 2, an advertisement is printed in advance on the delivery order form and, after the form is received, the destination information is added, making selection of an advertisement based on the destination information of the parcel not possible. Further, according to the system disclosed in PTL 3, while the advertisement can be selected based on the destination information of the parcel, this requires the entire distribution management system to be updated, resulting in an overall deterioration in efficiency. Furthermore, as described above, while the client and destination information is not registered in current delivery management systems from the viewpoint of personal information protection, the system disclosed in PTL 3 manages such information that is necessary to reflect the client and destination in advertisements and therefore requires measures for personal information protection, resulting in efficiency deterioration.

The present invention was made in view of problems such as described above, and it is therefore an object of the present invention to provide a system capable of providing without any decrease in efficiency a highly effective advertising function of an advertising business that utilizes a delivery order form, and returning to the client compensation for inclusion of an advertisement on the delivery order form.

### SOLUTION TO PROBLEM

The present invention is a delivery transfer system provided separately from a delivery management system of a delivery company, that is capable of transferring to the delivery company a parcel to be delivered to a delivery location specified by a client and returning to the client compensation for inclusion of specific information on a delivery order form. The delivery transfer system comprises: registration means wherein client information from the client is registered; receiving means that receives client information that identifies the client and delivery destination information of the parcel; specific information selection means that selects the specific information based on the delivery destination information; and reply sending means that sends to the client a reply with a parcel identification code, which is issued from the delivery management system, affixed to the parcel, and then registered in the delivery management system to identify the parcel, along with the selected specific information, and enables print out of the delivery destination information, the parcel identification code, and the specific information as the delivery order form.

According to this invention, because the client simply inputs and sends order form information, including delivery destination information, order form completion and the amount of time and effort required are substantially the same as those of prior art. Additionally, since the delivery transfer system (server) is provided separately from the delivery management system (server) of the delivery company, the delivery transfer system does not entail any changes to the delivery management system of the delivery company. That is, the delivery transfer system is efficient for both the client and the delivery company. Furthermore, the delivery transfer system makes it possible to operate an advertising business that employs delivery order forms on which specific information is printed based on the delivery destination information of the parcel, making it possible to achieve a business that returns to the client compensation for the advertisement in accordance with the high advertisement effect and reduce delivery costs. Furthermore, since personal information is handled on the delivery transfer system that is provided separately from the delivery management system publicly accessible on the Internet that discloses the distribution center where the parcel is currently located, the delivery transfer system also offers superior personal information protection. Here, to return to the client compensation for inclusion of specific information on the delivery order form, the advertiser must be able to confirm that the advertisement was attached to the parcel and that delivery was completed. According to this invention, although the delivery transfer system is provided separately from the delivery management system of the delivery company, the parcel identification codes are shared on both systems, making it possible for the advertiser to confirm delivery completion from the parcel identification code via the delivery management system.

In the above-described invention, the specific information selection means may select the specific information based on the delivery location within the delivery destination information. According to this invention, information that is more beneficial for the recipient is sent, making it possible to provide a highly effective advertising function.

In the above invention, the delivery transfer system may further comprise parcel identification code acquisition means that acquires from the delivery management system a plurality of parcel identification codes that identifies the parcels. According to this invention, a plurality of parcel identification codes can be promptly shared between the delivery transfer system and the delivery management system, making it possible to efficiently manage parcel identification codes even though the delivery transfer system is a management body that is different from the delivery company.

In the above invention, the reply sending means may enable print out of the delivery order form on a medium distributed to the client in advance. According to this invention, management of the delivery order form is simple, making it possible to prevent fabrication of a false delivery order form and, in turn, execute management efficiently.

Furthermore, the present invention is a delivery order form printing program used in a delivery transfer system provided separately from a delivery management system of a delivery company, that is capable of transferring to the delivery company a parcel to be delivered to a delivery location specified by a client and returning to the client compensation for inclusion of specific information on a delivery order form. The delivery order form printing program comprises: an input routine of receiving input of at least delivery destination information of the parcel; a transmission routine of transmitting the client information and the delivery destination information to the delivery transfer system; a reception routine of receiving a parcel identification code, which is issued from the delivery management system, attached to the parcel, and then registered in the delivery management system to identify the parcel, along with the selected specific information; and a printing routine of printing out the delivery destination information, the parcel identification code, and the specific information as the delivery order form.

According to this invention, because the client simply inputs order form information, including delivery destination information, using the delivery order form printing program, order form completion and the amount of time and effort required are substantially the same as those of prior art. Furthermore, since the delivery transfer system is provided separately from the delivery management system of the delivery company, the delivery transfer system does not entail any changes to the delivery management system of the delivery company. That is, the delivery transfer system is efficient for both the client and the delivery company. Furthermore, According to this invention, since personal information is sent to and managed by the delivery transfer system that is separate from the delivery management system publicly accessible on the Internet that discloses the distribution center where the parcel is currently located, the delivery transfer system also offers superior personal information protection. Furthermore, According to this invention, a delivery order form on which specific information is printed based on the delivery destination information of the parcel can be printed at the site of the client, making it possible to provide an effective advertisement that is viewed by at least two persons, the client and the recipient.

In the above invention, the printing routine may print out the delivery order form on a medium distributed to the client in advance. According to this invention, management of the delivery order form is simple, making it possible to prevent fabrication of a false delivery order form and, in turn, enhance management efficiently.

In the above-described invention, the delivery order form may be provided with a detaching section detachable from the main body in at least one area, and the printing routine may print the specific information in the detaching section. This makes it possible for the specific information printed on the detaching section to be detached from the delivery order form and utilized, thereby achieving a highly effective advertising function.

### BRIEF DESCRIPTION OF DRAWINGS

FIG. 1 is a hardware configuration diagram that includes the delivery transfer server according to the present invention.

FIG. 2 is a general outline view of the flow of a service that uses the delivery transfer server according to the present invention.

FIG. 3 is an outline drawing of the input and output of data, including that of the delivery transfer server according to the present invention.

FIG. 4 is a flowchart of a part of the delivery transfer server service according to the present invention.

FIG. 5 is a flowchart of a part of the delivery transfer server service according to the present invention.

FIG. 6 is a flowchart of a part of the delivery transfer server service according to the present invention.

FIG. 7 is a flowchart of a part of the delivery transfer server service according to the present invention.

FIG. 8 is a plane view of a dedicated sheet used for a service of the delivery transfer server according to the present invention.

FIG. 9 is a cross-sectional view along cross section A-A in FIG. 8.

FIG. 10 is a plane view of a delivery order form used for the delivery transfer server service according to the present invention.

FIG. 11 is a plane view of a delivery order form used for the delivery transfer server service according to the present invention.

FIG. 12 is a plane view of a delivery order form used for the delivery transfer server service according to the present invention.

### DESCRIPTION OF EMBODIMENTS

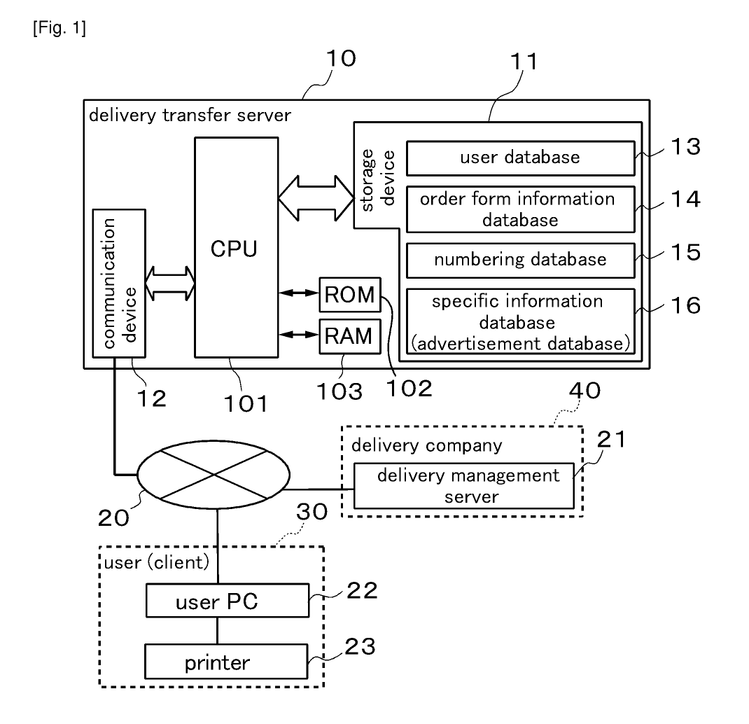

The inventors of this invention came up with the idea of a system (server) for transferring delivery of a parcel to a delivery company that is to deliver that parcel to a delivery location specified by a client in accordance with a delivery order form, i.e., the idea of a system that handles the period from when the client creates a delivery order form to when the client requests delivery of a parcel to a delivery company, researched the idea, and completed the present invention. An embodiment according to the present invention will now be described in detail with reference to FIG. 1 to FIG. 12.

First, the system configuration will be described.

As shown in FIG. 1, a delivery transfer server 10 for transferring delivery of a parcel to a delivery company 40 includes a storage device 11, and a communication device 12 for connection to an Internet line 20. Furthermore, the delivery transfer server 10 includes a CPU 101, and a ROM 102 and a RAM 103 that store programs, and the like. Additionally, a monitor device and an input/output device such as a keyboard (not shown) are connected to the delivery transfer server 10.

The storage device 11 comprising a hard disk, etc., of the delivery transfer server 10, comprises a user database 13 for storing information of a user (client) 30 who requests delivery of a parcel, an order form information database 14 for storing order form information including delivery destination information of a recipient of a parcel, etc., a numbering database 15 for storing parcel identification codes for identifying a parcel from other parcels in a delivery management server 21 of the delivery company 40, and a specific information database 16 (hereinafter referred to as advertisement data base) for storing specific information such as various advertisements, coupons, and lottery tickets, in accordance with the order form information, which are described in detail later.

The delivery transfer server 10 is connected with the delivery management server 21 of the delivery company 40 via an existing infrastructure for communication with the Internet line 20. Furthermore, while only one delivery company 40 is indicated here, the delivery transfer server 10 may be connected with the delivery management servers of a plurality of delivery companies. Additionally, the delivery transfer server 10 and the delivery management server 21 of the delivery company 40 may be connected by a dedicated line for reasons such as the confidentiality of data transmission and reception. On the other hand, a user PC 22 located at home or workplace of the user 30 who requests delivery of a parcel is also connected to the Internet line 20. A printer 23 is connected to the user PC 22.

Next, the utilization flow and program of the above-described system will be described.

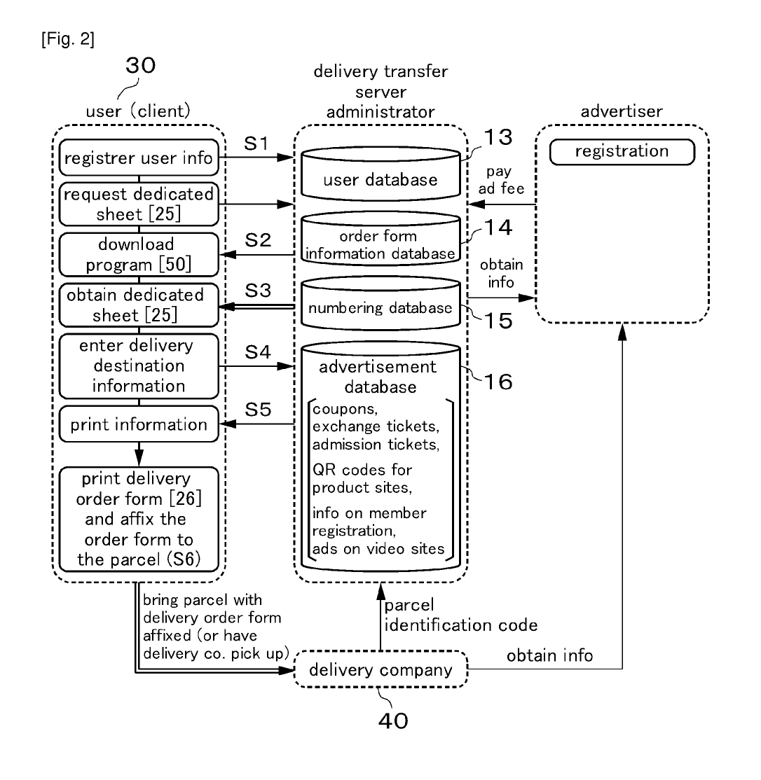

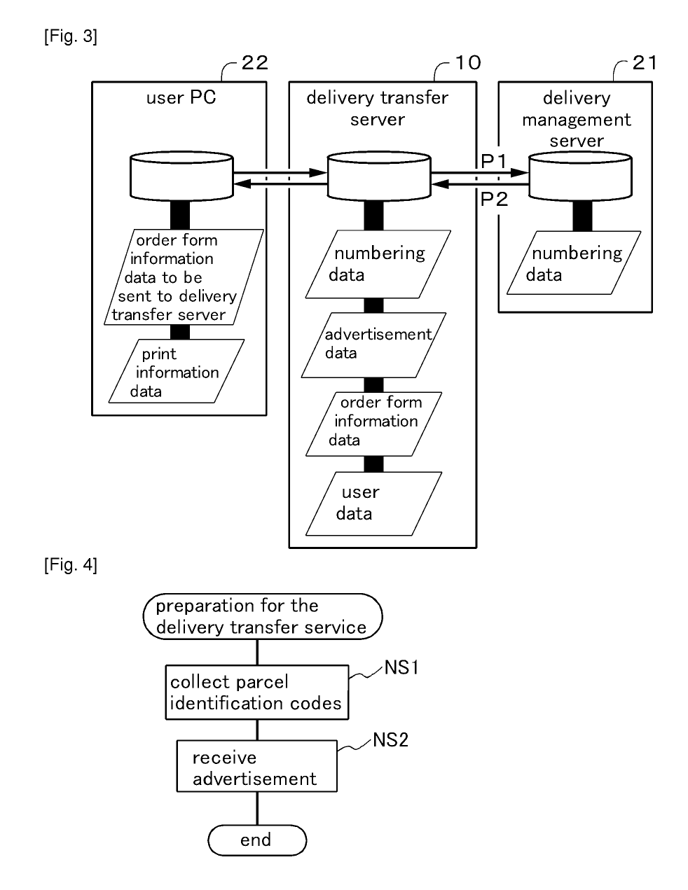

The delivery service flow which includes the transfer of delivery of a parcel to the delivery company 40, and the program of each part used therein will now be described with reference to FIG. 4 to FIG. 6 in combination with FIG. 2, which is a general outline view of the delivery service flow which includes transfer of the delivery of a parcel to the delivery company 40, and FIG. 3, which is an outline view of the input and output of data.

Specifically, referring to FIG. 2 and FIG. 3 in combination with FIG. 4, the administrator of the delivery transfer server 10 collects parcel identification codes in preparation for the delivery transfer service (NS1). That is, the administrator selects the delivery company 40 and operates the input/output device (not shown) of the delivery transfer server 10 to access the delivery management server 21 of the selected delivery company 40 via the Internet line 20 and request collective assignment of a plurality of parcel identification codes (refer to P1 arrow of FIG. 3).

The term “parcel identification code” used here refers to a code sequence that is issued in advance from the delivery management server 21, attached to a parcel, and then transmitted to and verified and registered in the delivery management server 21 to identify the parcel. In the delivery management server 21, an issued parcel identification code cannot be assigned until completion of its use has been verified, thereby ensuring that parcels having the same attached parcel identification code will not be in a state of delivery at the same time. The combination of codes of the parcel identification code differs for each delivery management server 21, i.e., for each delivery company 40, ensuring that a parcel identification code issued from a certain delivery management server 21 is not verified and registered in another delivery management server.

If the delivery management server 21 approves the request for the assignment of parcel identification codes, the parcel identification codes sent via the line are stored in the numbering database 15 (refer to P2 arrow of FIG. 3). On the other hand, if the request for the assignment of parcel identification codes is not approved by the delivery management system 21, the delivery management server 21 of the delivery company 40 is accessed once again at the stage where a reply is sent with print information to the user 30 to assign the parcel identification code individually, as described later.

Note that a parcel identification code may be transferred from the delivery order form that has been assigned that parcel identification code and distributed to the service site, etc., and stored in the numbering database 15 by the administrator of the delivery transfer server 10. In such a case, since the parcel identification code is disclosed on the delivery order form by means of a one-dimensional or two-dimensional barcode, a hand-held terminal reader or the like (not shown) capable of reading that code is preferably connected to the delivery transfer server 10 directly or indirectly by a public line or dedicated line, thereby further simplifying the transfer and storage of the parcel identification code in the numbering database 15.

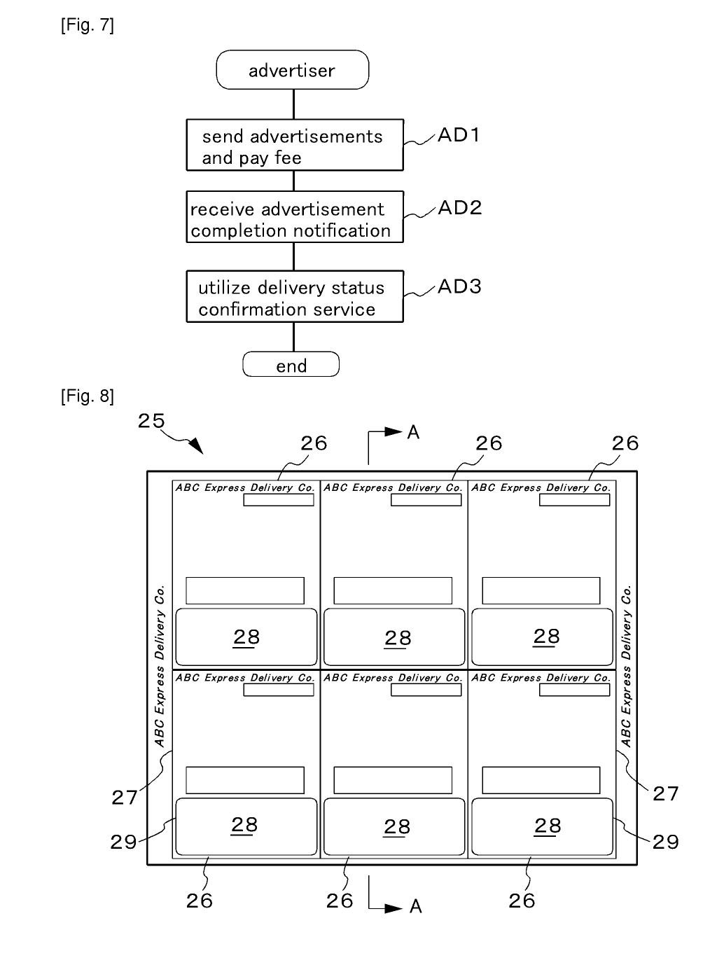

Next, the administrator of the delivery transfer server 10 then receives a preferred advertisement to be posted on a delivery order form 26 to be described later (refer to NS2 of FIG. 4 in combination with AD1 of FIG. 7). Such advertisements are collected via websites and the like placed on the delivery transfer server 10, and then stored in the advertisement database 16 of the delivery transfer server 10 upon assignment of an advertisement identification code per advertisement. Advertisements of a paper medium or the like that are collected offline are assigned an advertisement identification code per advertisement via work performed by the administrator of the delivery transfer server 10, and stored in the advertisement database 16 of the delivery transfer server 10.

The advertisements stored in the advertisement database 16 include general advertisements as well as a wide variety of specific information related to advertising services such as coupons that can be used at predetermined commercial facilities, exchange tickets for products and services, admission tickets to specific events, QR codes that invite authorized access to product sites or video sites, information on member registration for specific services, book indexes or magazine headlines, and the like.

Now, the specific information (hereinafter simply referred to as “advertisement”), including general advertisements, stored in the advertisement database 16 of the delivery transfer server 10 is categorized according to the location information and customer information preferred for distribution of the advertisement as set by the advertiser, and developed into a searchable database to enable association with the order form information described later. For example, the specific information is made searchable by categorizing the information in response to a recipient address of delivery destination information into advertisements of commercial facilities affiliated with the city, prefecture(state), or the like associated with that address, or by categorizing the information in relation to the contents for which delivery was requested.

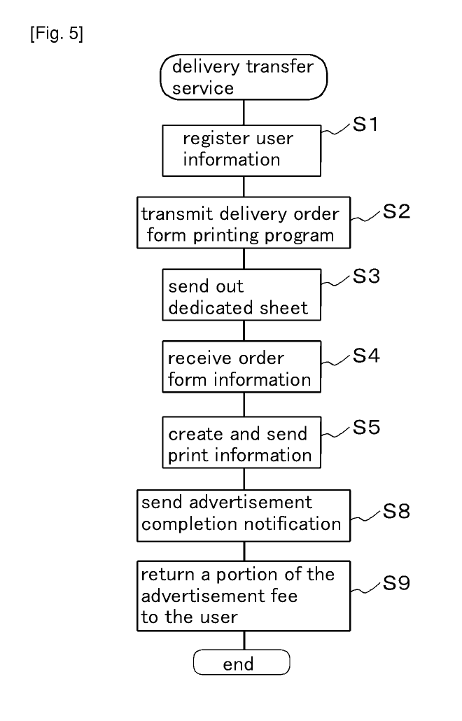

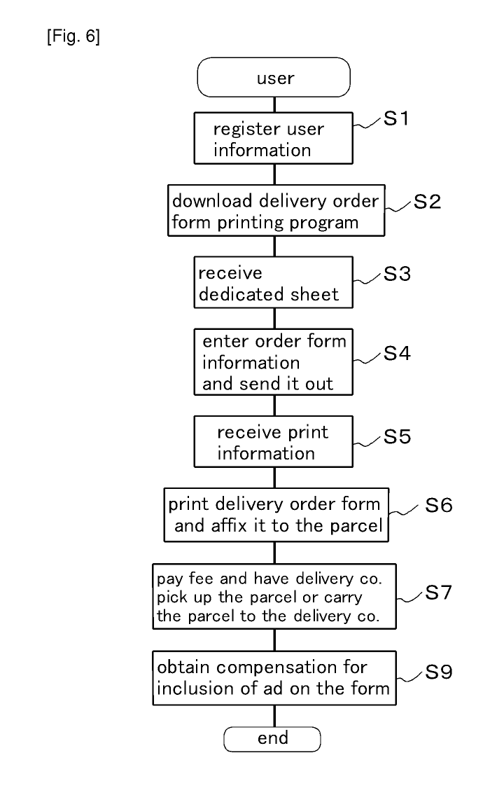

Specifically, referring to FIG. 2 and FIG. 3 in combination with FIG. 5 and FIG. 6, according to the delivery transfer service, first the user 30 registers user information (S1; note that the corresponding processes between the delivery transfer server and user are denoted using the same reference numeral). The user 30 who wants to utilize the delivery transfer service from the delivery transfer server 10 sends required user information, such as his/her name, company name, and address in Japanese or English characters along with the corresponding kana (this kana is basically used to indicate pronunciation of Chinese characters included in the Japanese characters), his/her fixed telephone number and cell phone number, and his/her e-mail address, to the delivery transfer server 10 using a special form available on the home page (hereinafter abbreviated as “HP”) of the delivery transfer server 10 or a special form attached to an e-mail, and registers himself/herself as a user. The delivery transfer server 10 that receives such user information searches the user database 13 to check whether or not the user 30 is already registered. If the user 30 is not registered, the delivery transfer server 10 registers the user information of the user in the user database 13 and issues an ID and password. After this point, when the user 30 accesses the gate HP of the delivery transfer server 10 and enters his/her ID and password, the user 30 is allowed to access the main HP without any search for or verification of user registration, and to perform operations such as downloading or updating a delivery order form printing program 50 described later, requesting transmission of a dedicated sheet 25, and browsing and changing user information. Such mechanisms are publicly known and descriptions thereof will be omitted. Now, the term “gate HP” used here refers to the top page of the HP, and displays ID and password areas for accessing the contents of the HP. The term “main HP” refers to the page that appears after the ID and password have been entered on the gate HP, and discloses the contents of the HP. On the other hand, when the user 30 is already registered, a reply indicating so is sent to the user 30, who is then prompted to enter his/her already issued ID and password.

Next, the registered user 30 downloads the delivery order form printing program 50 (S2). The user 30 uses his/her ID and password to access the delivery transfer server 10 and displays the main HP, and then downloads to the user PC 22 the delivery order form printing program 50 of the delivery order form printing program storage area (not shown) of the storage device 11 from the menu. The delivery order form printing program 50 may also be downloaded after incorporation of a portion of the user information of the user database 13. With this arrangement, the user 30 does not need to enter a portion of the user information after he/she first uses the delivery order form printing program 50.

Next, the user 30 who downloaded the delivery order form printing program 50 requests to send out the dedicated sheet (S3) by postal mail. That is, when the user 30 requests transmission of the dedicated sheet 25 from the menu of the main HP, the delivery transfer server 10 that receives the request, sends via the administrator thereof the dedicated sheet 25 that states predetermined information, such as the service name, business entity, and the name and address of the user 30, to the corresponding address registered in the user database 13 for the user 30 by postal mail. With this arrangement, the dedicated sheet 25 is only used by the user 30, thereby preventing impersonation. Note that the configuration may be designed so that such a process can be performed from the delivery order form printing program 50, and more reliable verification of identity can be achieved when a portion of the user information of the user database 13 is incorporated in the delivery order form printing program 50. Along with the dedicated sheet, packaging materials for shipping, such as warning labels, attention labels, glue, envelopes, and boxes, may be sent as well.

Next, the delivery destination information is entered and sent by the user 30 (S4). When the user 30 wants to request the delivery company to deliver a parcel, the user 30 starts the delivery order form printing program 50 on the user PC 22. The delivery order form printing program 50 prompts the user 30 to enter order form information including predetermined delivery destination information, making the user 30 enter, for example, to and from locations, client (sender) and recipient names and telephone numbers and zip codes, parcel contents, and the like. Note that predetermined entries may be saved in a predetermined storage area within the user PC 22 so that the same information does not need to be repeatedly entered in the future. When the order form information is sent to the delivery transfer server 10, a confirmation page from the HP appears on the user PC 22. The order form information is then confirmed when an OK response is sent, or permitted to be re-entered or revised when a cancel or revise response is made. Note that such processes are also publicly known, and descriptions thereof will not be discussed in detail.

It should be noted that implementation is also possible using an ASP (Application Service Provider) that directly sends the entered information from the user PC 22 to the delivery transfer server 10 without the user 30 downloading the delivery order form printing program 50 and executing data processing. In such a case, the entered information is associated with the user 30 and, for example, the addresses of the client and recipient are saved in a history storage database of the delivery transfer server (not shown) or selected from a list at the time of information entry, making it possible for a predetermined display to appear each time for frequent users. Such processes are publicly known, and descriptions thereof will not be discussed in detail. Such an arrangement saves the user 30 much time and effort in information entry, and eliminates the time and effort required for downloading and the need for updating the delivery order form printing program 50, thereby further improving user friendliness.

Furthermore, a predetermined questionnaire (not shown) may be sent to the user PC 22 from the delivery transfer server 10 after transmission and establishment of such order form information to acquire questionnaire information. The advertisements of the advertisement database 16 described later can then be selected based on the contents of such questionnaire information. With this arrangement, an advertisement that matches the preferences of the client can be sent.

Next, advertisements are selected and print information is created (S5). In the delivery transfer server 10, advertisements are selected either randomly or in a predetermined sequential order from the advertisement database 16 in accordance with the received order form information. Further, a single parcel identification code is selected in a sequential manner from the numbering database 15. That is, as described above, in response to the recipient address in the recipient information included in the order form information, commercial facility advertisements, coupons, etc., affiliated with or related to the city, prefecture(state), or the like associated with that address are found in and selected from the advertisement database 16 categorized and registered according to location information, marketing information, and the like. Selection of the specific information may also be entrusted to the user 30 who potentially has knowledge of the preferences of the recipient, or may be based on the results of the above-described questionnaire. A reply containing specific information, which includes the advertisements and the like in combination with the individual identification codes thereof, and print information, which includes the order form information and parcel identification code required to create the order form, is then sent to the user PC 22.

Here, as described above, in a case where the parcel identification code has not been assigned in the numbering database 15, or in a case where assignable codes are all used, a parcel identification code is individually assigned from the delivery management server 21 of the delivery company 40.

Next, the user 30 who receives the reply containing print information prints out a delivery order form 26 (refer to FIG. 8) and affixes the order form to the parcel (S6). The user PC 22 that receives the reply containing print information prints the order form information, specific information, and parcel identification code that constitute the print information, as well as information related to the client, on the dedicated sheet 25 (refer to FIG. 8). Specifically, the display form is interfaced with the reading terminal of the delivery company 40, and the parcel identification code is printed as a one-dimensional or two-dimensional barcode, for example.

Next, the user 30 carries the parcel with the delivery order form 26 affixed thereto to, or requests parcel collection by, a site or contracted service office of the delivery company 40, pays a predetermined fee, and requests the transportation company 40 to deliver the parcel (S7). The delivery company 40 is capable of reading the individual identification code encoded in a one-dimensional barcode printed on the delivery order form 26 using a dedicated terminal, etc., and therefore registers the code in the delivery management server 21, setting the code as the parcel ID in the delivery management server 21. The delivery company 40 then delivers the parcel with an attached ID comprising this parcel identification code under the management of the delivery management server 21. This process is publicly known, however, and a detailed description thereof will not be discussed in detail.

On the other hand, the delivery transfer server 10 that sent the print information to the user PC 22 sends the individual identification code that identifies the advertisement, the delivery company 40, the parcel identification code, and an advertisement completion notification to the advertiser (S8), letting the advertiser know upon receipt that his/her advertisement was attached to the delivery order form (refer to AD2 of FIG. 7). Now, the advertiser can utilize a delivery status confirmation service via the Internet, which is a service provided by the delivery management server 21 (AD3 of FIG. 7). That is, such a service uses the notified parcel identification code to inform the advertiser that the delivery order form (parcel) that includes the advertisement has been delivered to the recipient and, since the sites of the delivery company 40 through which the parcel has passed are understood even though the addresses of the client and recipient cannot be identified, to inform the advertiser of the different locations from which and to which the parcel with the requested advertisement was carried and the corresponding times. That is, the delivery transfer server 10 is superior from the viewpoint of personal information protection as it acquires required information.

Next, the administrator of the delivery transfer server 10 returns a portion of the advertisement fee from the advertiser to the user (S9). With this arrangement, the user obtains compensation for inclusion of an advertisement on the delivery order form from the advertiser, making it possible to reduce the delivery cost. With the delivery transfer server 10 making it possible to provide an advertisement having a high probability of being viewed and recognized by at least two persons, the client and the recipient, as in the present embodiment, a high advertisement fee can be set, making it possible to achieve a high return as well. Furthermore, if the individual identification code of the advertisement is stated on the parcel, the individual identification code (sometimes common to the parcel identification code as described later) can be returned to the administrator of the delivery transfer server 10 after the delivery order form 26 has been submitted to the delivery destination of the parcel and the advertisement contents stated thereon have been used by the recipient, that is, for example, when the recipient participates in a campaign of a site or a service provided at a store, thereby enabling measurement of the effectiveness of the advertisement. Usage can then be reported to the advertiser, and the advertisement fee can be made subordinate to the measurement results of advertisement effectiveness.

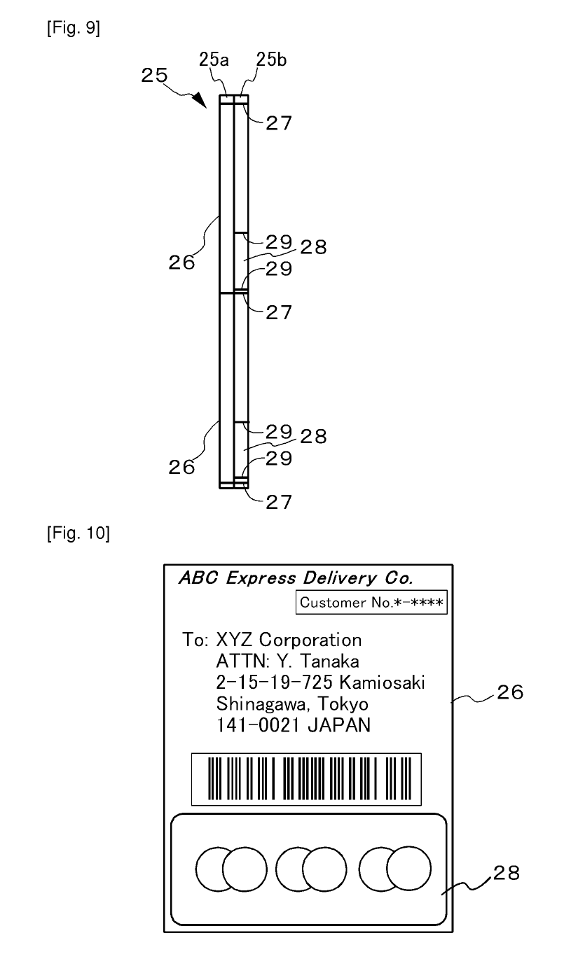

As shown in FIG. 8 and FIG. 9, the dedicated sheet 25 is a multi-layered sheet having a two-layered structure of a base sheet 25a and a detaching sheet 25b, wherein the upper layer detaching sheet 25b is detachably adhered to the base sheet 25a. The dedicated sheet 25 is provided with a perforated line 27 that passes through both layers so that it can be separated into at least two or more delivery order forms (individual slips) 26. Each of the delivery order forms 26 is provided with a cutout line 29 on the detaching sheet 25b to provide a detaching section 28 detachable from the base sheet 25a.

When the user 30 inserts the dedicated sheet 25 into the printer 23, the advertisement is printed in the detaching section 28 and the order form information, including the recipient information, and parcel identification code are printed in a section other than the detaching section 28, by the delivery order form printing program 50.

As shown in FIG. 10, the user 30 separates the printed dedicated sheet 25 into individual delivery order forms 26 and affixes the delivery order form 26 to a predetermined parcel.

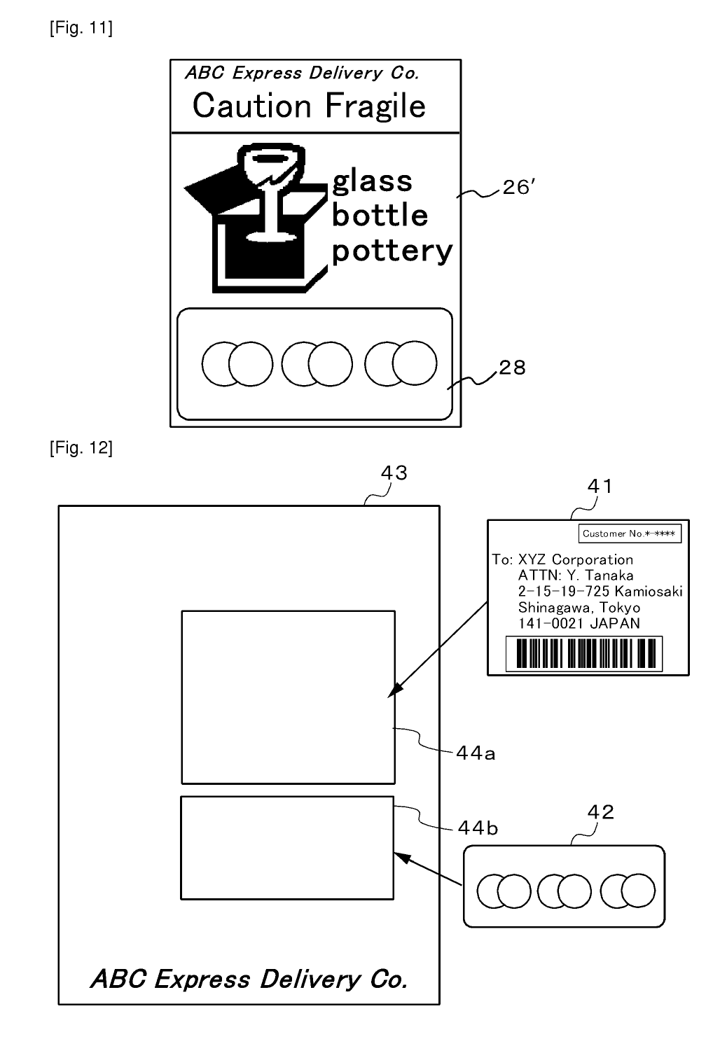

Furthermore, a function may be provided to the delivery transfer server 10 and the delivery order form printing program 50 so that, as shown in FIG. 11, a warning slip 26′, such as a warning label or attention label indicating, for example, that the contents of the parcel are fragile, the parcel should not be placed upside-down, or the parcel contains a precision part, can be printed in addition to the delivery order form 26. In such a case as well, the same dedicated sheet 25 can be used to print advertisements, etc., of specific information on the detaching section 28 and the warning contents on a section other than the detaching section 28.

While an advertisement of the advertisement database 16 is identified by an advertisement identification code as an example of a provided service in the above-described embodiment, the advertisement identification code may be matched with the parcel identification code stored in the numbering database 15, i.e., the advertisement identification code attached to the advertisement may be in accordance with the parcel identification code. That is, when the parcel identification code is selected as described later, a specific advertisement of the advertisement database 16 is selected. This makes it possible to provide a service that matches the advertisement included on the delivery order form with the parcel identification code stated on the delivery order form. For example, consider a case where a lottery is held with the parcel identification codes and the lottery guidelines and information indicating that the lottery drawing results will be announced in newspapers or on a specific HP, are stated in an advertisement. Such an advertisement identification number can be used as a highly reliable code sequence, even for sweepstakes and the like, since the codes are managed so that they are not simultaneously generated by the delivery management server 21 and they are difficult for a third party to fabricate.

Further, since information is stated on the delivery order form via the delivery transfer server 21 or the delivery order form printing program 50 rather than directly by the client in an example of a provided service of the above-described embodiment, the print information excluding specific information and the information related to the user 30 (client) may be stated using a special code serving as a common language between the delivery transfer server 21 and the delivery company 40. With this arrangement, the parcel can be delivered by the delivery company 40 without a third party gaining knowledge of the personal information stated on the delivery order form. Similarly, when delivery of a parcel that was purchased on the Internet, such as from a specific Internet site or in an Internet auction, is requested and a three-party transaction is made over the Internet among, for example, a seller, a first buyer (reseller), and a second buyer who is to purchase the item from the first buyer, the parcel can be delivered to the user 30, who is the second buyer, without making the personal information of the seller, such as his/her name, known to the second buyer and without making the personal information of the second buyer, such as his/her name, known to the seller.

As a further example of a provided service of the above-described embodiment, in the step (S5) of sending to the user PC 22 a reply with print information, including the parcel identification code and the order form information required to create an order form, the print information may be uploaded to the main HP of the delivery transfer server 10 that is accessible using an ID and password, either after a reply is sent or without a reply being sent. The user 30 then accesses the main HP of the site through (printer connected) computer systems located at the distribution center of the delivery company 40 or the contracted service office to be requested to deliver the parcel, prints out the delivery order form at the center or at the contracted service office, and similarly affixes the order form to the parcel. With this arrangement, even for an individual who does not own a printer, the same service as the above-described embodiment is achieved.

As yet another example of a provided service of the above-described embodiment, the specific information may be printed on a card 41 and the order form information and parcel identification code may be printed on a separate card 42 without using the dedicated sheet 25, as shown in FIG. 12. These cards 41 and 42 may then be inserted in transparent pockets 44a and 44b on the front of a dedicated envelope 43 used for delivery. With this arrangement, particularly in a case where the parcel is a thin parcel inserted in an envelope, such as a document, the time and effort required to affix the delivery order form 26 are reduced, resulting in superior user friendliness.

According to the above-described embodiment, the user 30 simply enters the order form information in the delivery order form printing program 50, eliminating the time and energy required for entering additional information. Further, since the order form information is completed by the user 30 or the delivery transfer server 10, at the very least, the time and energy required for the delivery company 40 to write down and input the order form information are no longer required. Additionally, an advertisement business that utilizes the delivery order form 26 on which is printed an advertisement that reflects the order form information of the recipient of the parcel by the delivery transfer server 10 which is separately provided from the delivery management server 21 of the delivery company 40 is achieved. That is, the delivery transfer server 10 does not entail significant changes to the delivery management server 21 of the delivery company 40. Therefore, the delivery transfer server 10 does not reduce the efficiency of either the user 30 or the delivery company 40. Furthermore, since personal information is handled on the delivery transfer system that is provided separately from the delivery management system publicly accessible on the Internet that discloses the distribution center where the parcel is currently located, the delivery transfer system also offers superior personal information protection. Here, to return to the client compensation for inclusion of specific information on the delivery order form 26, it is necessary for the advertiser to confirm that the advertisement was attached to the parcel and that delivery was completed. According to the invention, although the delivery transfer server 10 is provided separately from the delivery management server 21 of the delivery company 40, the parcel identification codes are shared on both systems, making it possible for the advertiser to confirm delivery completion from the parcel identification code using a service of the delivery management server 21.

While the above has described representative embodiments of the present invention and modifications based thereon, the present invention is not limited thereto and suitable modifications can be made by those skilled in the art. As described above, the delivery order form printing program 50 may be an ASP, making combination with a member service that similarly involves an ID, such as a shopping service on the Internet, an auction site, or a provider, possible. Further, the contents stated on the delivery order form may be omitted via automatic recognition technology, such as an RFID (Radio Frequency Identification) system, or only a unique identification number of an RFID tag may be stated on the delivery order form, thereby making it possible to read the delivery order form in a non-contact manner and thus achieve a service that offers even further enhanced personal information protection. It will be apparent to those skilled in the art that various modifications can be made in the present invention without departing from the spirit or scope of the present invention.

### REFERENCE SIGNS LIST

10 delivery transfer server

13 user database

14 order form information database

15 numbering database

16 advertisement database (specific information database)

21 delivery management server

22 user PC

23 printer

25 dedicated sheet

26 delivery order form

28 detaching section

30 user (client)

40 delivery company

43 dedicated envelope

50 delivery order form printing program

1. A delivery transfer system provided separately from a delivery management system of a delivery company, that is capable of transferring to the delivery company a parcel to be delivered to a delivery location specified by a client and returning to the client compensation for inclusion of specific information on a delivery order form, comprising:
registration means wherein client information from said client is registered;
receiving means that receives client information that identifies said client and delivery destination information of said parcel;
specific information selection means that selects said specific information based on said delivery destination information; and
reply sending means that sends to said client a reply with a parcel identification code, which is issued from said delivery management system, affixed to said parcel, and then registered in said delivery management system to identify said parcel, along with said selected specific information, and enables print out of said delivery destination information, said parcel identification code, and said specific information as said delivery order form.

2. The delivery transfer system according to claim 1, wherein said specific information selection means selects said specific information based on the delivery location within said delivery destination information.

3. The delivery transfer system according to claim 1, further comprising parcel identification code acquisition means that acquires from said delivery management system a plurality of said parcel identification codes that identifies the parcels.

4. The delivery transfer system according to claim 1, wherein said reply sending means enables print out of said delivery order form on a medium distributed to said client in advance.

5. A delivery order form printing program used in a delivery transfer system provided separately from a delivery management system of a delivery company, that is capable of transferring to the delivery company a parcel to be delivered to a delivery location specified by a client and returning to the client compensation for inclusion of specific information on a delivery order form, comprising:
an input routine of receiving input of at least delivery destination information of said parcel;
a transmission routine of transmitting said client information and said delivery destination information to said delivery transfer system;
a reception routine of receiving a parcel identification code, which is issued from said delivery management system, attached to said parcel, and then registered in said delivery management system to identify said parcel, along with said selected specific information; and
a printing routine of printing out said delivery destination information, said parcel identification code, and said specific information as said delivery order form.

6. The delivery order form printing program according to claim 5, wherein said printing routine prints out said delivery order form on a medium distributed to said client in advance.

7. The delivery order form printing program according to claim 6, wherein said delivery order form is provided with a detaching section detachable from the main body in at least one area, and said printing routine may print said specific information in said detaching section.

8. The delivery transfer system according to claim 2, further comprising parcel identification code acquisition means that acquires from said delivery management system a plurality of said parcel identification codes that identifies the parcels.

9. The delivery transfer system according to claim 2, wherein said reply sending means enables print out of said delivery order form on a medium distributed to said client in advance.

10. The delivery transfer system according to claim 3, wherein said reply sending means enables print out of said delivery order form on a medium distributed to said client in advance.
